(19) United States
(12) Patent Application Publication
(10) Pub. No.: US 2005/0012722 A1
(43) Pub. Date: Jan. 20, 2005

(54) Touch screen

(76) Inventor: Hwa-Su Chon, Gyeonggi-do (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/750,661

(22) Filed: Dec. 31, 2003

(30) Foreign Application Priority Data
Jul. 18, 2003 (KR) 10-2003-0049120

(51) Int. Cl. G09G 5/00

(52) U.S. Cl. 345/173

(57) ABSTRACT

A touch screen improved with reflection rate of light, wherein a retardation film at a touch panel is laminated with special ink in multiple layers to pass through an anti-reflection treatment for reduction of reflection rate of light glaring on eyes caused by diffused reflection of light and for improvement of permeability rate of light coming from an LCD mounted thereunder, thereby optimizing a brightness of the touch screen.

### CROSS-REFERENCE TO RELATED APPLICATION

This application claims priority of Korean Application No. 10-2003-0049120, filed on Jul. 18, 2003.

### FIELD OF THE INVENTION

The present invention relates to a touch screen, and more particularly, to a touch screen with an anti-reflection treatment at a lower end surface of a touch panel to decrease reflection rate relative to light incident from outside and to increase permeability rate of light coming out of a liquid crystal display (LCD), thereby improving brightness of the screen.

### BACKGROUND OF THE INVENTION

Generally, a touch screen is a device wherein a character or a letter appearing on a screen may be touched by fingers or an object to enable input of data into a computer without using a separate input device such as a keyboard or a mouse. In other words, the touch screen, which is a screen attached with a special input device for receiving the position of a touch, is constituted to function as a screen of a general monitor attached with a touch panel. Various types of touch panels exist, and one widely-used type in automobiles is a so-called resistance film type touch panel, which transforms pressure changes applied from outside to resistance values to be input into a circuit substrate.

However, there is a disadvantage in the resistance film type touch screen thus described in that it has poor viewing and brightness characteristics, resulting in an inevitable set-up of the touch screen at a different angle from an instrument panel. This also leads to a deterioration of external appearance of the touch screen and a set-up of a separate member around the touch screen such as an awning or the like in order to block a light coming from the outside.

### SUMMARY OF THE INVENTION

Embodiments of the present invention provide a touch screen having improved light reflection characteristics wherein a retardation film at the touch panel is laminated with special ink in multiple layers to pass through an anti-reflection treatment for reduction of reflection rate of the light to reduce glare caused by diffused reflection of light and for improvement of permeability rate of light coming from an LCD mounted thereunder, thereby optimizing a brightness of the touch screen.

Embodiments of the present invention comprise a touch panel including an upper structure formed as a lamination of a polarizing film, and a retardation film and a first glass plate, a lower structure formed as a lamination of a second glass plate and a retardation film, conductor coating layers each arranged on an opposing surface of the upper and lower structure and transparent ink sealed in a space between the conductor coating layers; and an LCD mounted under the touch panel. The touch panel is laminated with an anti-reflection (AR) film applied with anti-reflection treatment.

Furthermore, the AR film is laminated to a surface under the retardation film of the lower structure.

### BRIEF DESCRIPTION OF THE DRAWINGS

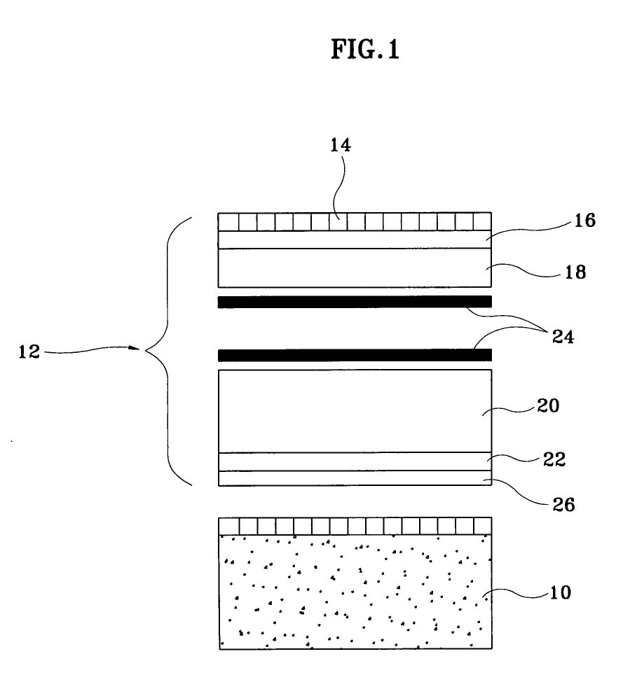

For fuller understanding of the nature and objects of the present invention, reference should be made to the following detailed description taken in conjunction with the accompanying drawing in which FIG. 1 is a schematic cross-sectional view of a touch screen according to a preferred embodiment of the present invention.

### DETAILED DESCRIPTION OF THE PREFERRED EMBODIMENTS

Hereinafter, a preferred embodiment of the present invention will be described in detail with reference to the accompanying drawing.

As shown in FIG. 1, the cross-sectional view of a touch screen type monitor according to an embodiment of the present invention includes a touch panel 12 on top of a Liquid Crystal Display (LCD) 10. The touch panel 12 includes a series of laminated layers. An upper structure includes a polarizing film 14 and a retardation film 16 respectively laminated on a first glass plate 18 having a thickness of approximately 0.2 mm. A second glass plate 20 having a thickness of approximately 1.1 mm is mounted underneath the upper structure. A lower structure having a retardation film 22 is mounted underneath the second glass plate 20.

Furthermore, between the first glass plate 18 having a thickness of approximately 0.2 mm at the upper structure and the second glass plate 20 having a thickness of approximately 1.1 mm at the lower structure, there are positioned transparent conductor coating layers 24. Layers 24 may be Indium Tin Oxide (ITO). Each such layer is spaced out at a minute distance therebetween.

At a void between the conductor coating layers 24, there is filled a special transparent ink (not shown) that transforms input changes applied from outside to resistance values and inputs same to a circuit substrate. The special ink may be a silica sol or the like.

The polarizing film 14 is treated on a surface thereof with an anti-glare treatment for reducing the reflection rate of light glaring on eyes by diffusing reflection of light irradiated from the outside

The retardation film 22 at the lower structure is laminated thereunder with the AR film 26 treated with an anti-reflection treatment, where the AR film 26 is made of special ink laminated in layers on the retardation film 22 for absorbing the diffused and reflected light. Preferably these laminations are in five layers.

As a result, the AR film 26 laminated on the retardation film 22 can absorb the diffused and reflected light from the LCD 10. The surface of the polarizing film 14 is applied with anti-glaring treatment to diffuse the light coming from the outside and to lower the reflection rate of light glaring on a viewer's eyes while light from the LCD 10 is diffused. In other words, the AR film 26 laminated on the retardation film 22 improves the permeability rate of light output from the LCD 10 while the reflection rate of light coming from outside and diffused by the touch panel 12 is decreased.

As a result, the brightness of screen output from the LCD 10 and recognized via the touch panel 12 can be improved (1.43% improved against the prior art) in response to increase of the permeability rate while reflection rate of light reflected from outside via the touch panel 12 can be decreased to thereby improve viewability of screen (1.28% improved against the prior art).

Furthermore, when a structure of a touch screen type monitor thus described is adopted, the viewability of a screen can be improved such that an installation direction of the monitor can be mounted in accordance with a set-up angle of an instrument panel, thereby enhancing the appearance of the vehicle interior.

Still furthermore, the AR film 26 laminated on the retardation film 22 is mounted underneath the lower structure of the touch panel 12, such that damage or contamination of the touch panel 12 caused by being brought into contact with a certain portion of a body or a tool can be also obviated.

As apparent from foregoing, there is an advantage in a touch screen with an improved reflection rate thus described according to the present invention in that a retardation film at the touch panel is laminated with special ink in multiple layers to pass through an anti-reflection treatment for reduction of the reflection rate of light that would otherwise create glare caused by diffused reflection of light and for improvement of permeability rate of light coming from an LCD mounted thereunder, thereby optimizing a brightness of the touch screen.

1. A touch screen improved with reflection rate of light comprising:
a touch panel including an upper structure formed as a lamination of a polarizing film, a retardation film and a first glass plate, a lower structure formed as a lamination of a second glass plate and a retardation film, conductor coating layers each arranged on an opposing surface of the upper and lower structure, and transparent ink sealed in a space between the conductor coating layers; and
an LCD mounted under the touch panel,
wherein the touch panel is laminated with an anti-reflection (AR) film applied with anti-reflection treatment.

2. The touch screen as defined in claim 1, wherein the AR film is laminated to a surface under the retardation film of the lower structure.
